(19) United States
(12) Patent Application Publication
(10) Pub. No.: US 2014/0336088 A1
(43) Pub. Date: Nov. 13, 2014

(54) LIQUEFIED POLYMER FRACTURING FLUID THICKENER AND PREPARATION METHOD THEREOF

(71) Applicants: Yan Zheng, Beijing (CN); Shusheng Li, Beijing (CN); Yujian Luo, Beijing (CN); Xiaodan Bai, Beijing (CN); Lei Qiao, Beijing (CN)

(72) Inventors: Yan Zheng, Beijing (CN); Shusheng Li, Beijing (CN); Yujian Luo, Beijing (CN); Xiaodan Bai, Beijing (CN); Lei Qiao, Beijing (CN)

(21) Appl. No.: 14/259,436

(22) Filed: Apr. 23, 2014

(30) Foreign Application Priority Data
May 10, 2013 (CN) 201310172790.7

(51) Int. Cl. C09K 8/68

(52) U.S. Cl. CPC C09K 8/68
USPC 507/219

(57) ABSTRACT

The present invention relates to a liquefied polymer fracturing fluid thickener, which has evaluation indexes as: a density of 1.0-1.3 g/cm³; a gelling time less than or equal to 15 s; and a viscosity of its 1.0% solution greater than or equal to 30 mPa·s. The present invention also relates to a method for preparing said liquefied polymer fracturing fluid thickener.

### CROSS-REFERENCE TO RELATED APPLICATIONS

The present application claims priority under 35 U.S.C. §119 to Chinese patent application 201310172790.7, filed May 10, 2013, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Related Technical Field

The present invention relates to an instant-dissolving liquid polymer fracturing fluid thickener, or a liquefied thickener hereafter.

The present invention also relates to a method for preparing the liquefied thickener.

2. Background

Water-based fracturing fluid is among most critical technologies in improving oil/gas recovery. During a water-based fracturing process, solid fracturing fluid thickener consisting fine powders, such as guar gum powders, dry powders of synthetic polymer thickeners, are commonly used. Said thickeners' dispersing and hydrated tackifying capacities determine applications of the fracturing process, its fracturing quality and costs.

Currently, the fracturing process could be generally described as follows:

The first step, preparing a base fluid. Thickener powders are dispersed in water, then after a certain period of time they are fully swelled to form the base fluid having a certain viscosity;

The second step, conducting the fracturing process. The base fluid is mixed with a crosslinker and other agents to form the fracturing fluid.

The above 2-step of the fracturing process has following problems:
1. when preparing the base fluid, special equipment is required for mixing the thickener powders with the water; while “fish eyes” and partial agglomerations may be produced and which affect quality of the base fluid;
2. the flexibility of conducting the fracturing process is restricted, if there are special reasons lead to insufficient volume of the fracturing fluid or temporarily request for larger scale of the fracturing process, it might not be achieved in situ;
3. a variety of supplements are required, and steps to mixing them into the fracturing fluid are complicated, all of which increase difficulty of quality control for the fracturing fluid;
4. the thickener powders need a long period of time (more than 10 minutes) to be hydrated and swelled, which increase manpower and resource consumption;
5. a significant volume of the base fluid (10-30%) remains after the fracturing process, which increases costs for cleaning and treating containers thereof.

In order to overcome above shortcomings, technologies of diesel-based and water-based liquefied thickeners have been researched since 1980s. In 1993, Xi'an University and Tuha Oilfield cooperative researched and developed a low-residue boron crosslinked liquid guar gum fracturing fluid technology which may be used for on-site construction.

With the current increasing demands for the water-based fracturing fluid of guar gum, raw materials of guar are in shortly supply and their prices have gone up because its growth conditions restrict its planting area. Therefore, applications of the synthetic polymeric fracturing fluid thickener are gradually expending because of its thickening ability, gel breaking performance, less residue, and higher recovery rate. In order to overcome the shortcomings of the 2-step fracturing process and the guar gum, a novel technology for liquidating the synthetic polymeric fracturing fluid thickener may be needed.

### SUMMARY OF THE INVENTION

An objection of the present invention is to provide a instant dissolving liquefied thickener.

Yet another objection of the present invention is to provide a method of preparing the liquefied thickener.

according to the present invention, the liquefied thickener has following evaluating indexes:
1. a density 1.0-1.3 g/cm³;
2. a gelling time ≦15 s; and,
3. a viscosity of its 1.0% solution ≧30 mPa·s.

Said liquefied thickener is prepared by following steps:
1. preparing a water-soluble organic solvent compound; and,
2. introducing a fracturing fluid thickener powder, which is a synthetic polymer thickener.

According to one embodiment of the present invention, the synthetic polymer thickener has a formula as:

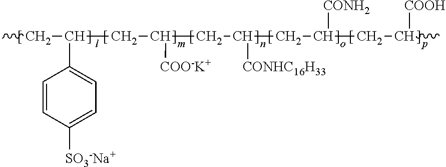

According to the present invention, the gelling time of said liquefied thickener is the time period for hydrating, swelling and dispersing processes.

Accordingly, the present invention has the advantages as follows:

1) No residue: during the whole fracturing process there is no residue of the liquefied thickener, therefore it is a low-damage fracturing fluid system.

2) Superior stability and performance of a fracturing fluid including: thermal-resistance, salt-resistance and shear-resistance; superior sand carrying and suspending capacities; reduced friction ratio, high rates of gel breaking and flowing back.

3) Ultra-fast instant dissolving: the hydrating, swelling and dispersing processes may be completed once thus the fracturing fluid may be prepared by a continuous operation with simply settings and equipment; the continuous operation allows the fracturing fluid to be mixed with sand and pumped immediately after prepared, thus eliminate on-site storages and liquid container for the reserves.

4) Simply preparation: the preparation of the present invention reduced components and steps of preparing, thus achieves high stability, high efficiency, low laboring, and simplified quality control.

5) Low cost: the preparation of the present invention minimizes requests for the equipment, which may be easy for relocation; its operation may be totally depended on demand, thus eliminates leftovers and prevents wasting; it reduces request for laboring and material costs, thus reduces overall costs.

### BRIEF DESCRIPTION OF DRAWINGS

FIG. 1 is a flowchart illustrating one embodiment of the present invention.

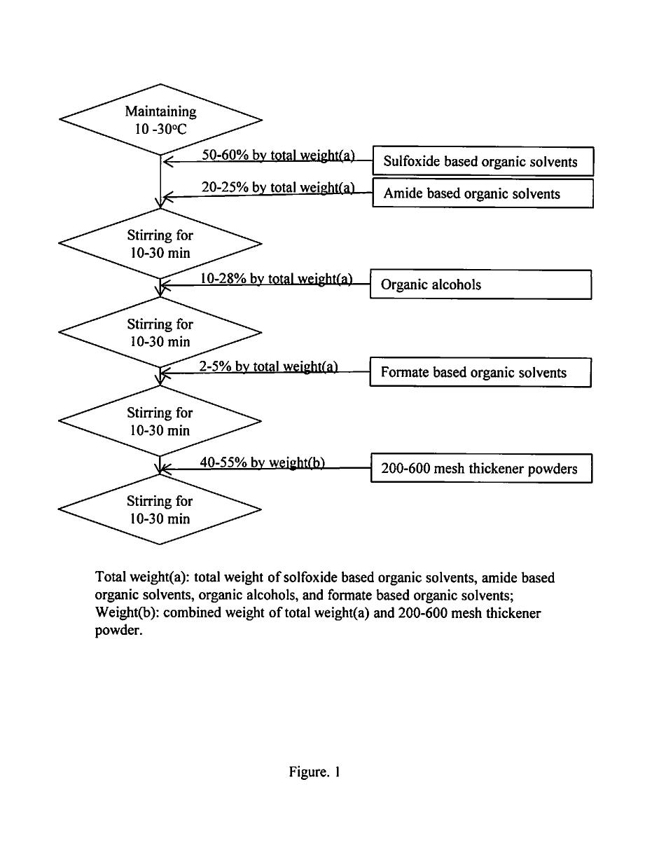

Table 1A&B are lists showing components that might be applied to one embodiment of the present invention showing in FIG. 1.

### DETAILED DESCRIPTION OF THE INVENTION

The present invention is related to a liquefied polymer fracturing fluid thickener (hereafter “liquefied thickener”). Said liquefied thickener is a homogeneous mixture of a synthetic polymer thickener and water-soluble organic solvent solution. Said synthetic polymer thickener (hereafter also termed “thickener powder”) is described in Chinese patent application having an application No. 201110223102.6.

Accordingly, the thickener powder has a molecular structure as:

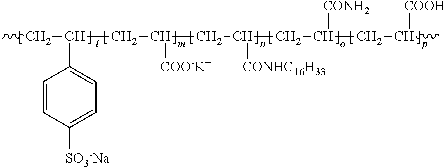

Accordingly, the liquefied thickener disclosed and prepared by the present invention is a milky dispersion, wherein the thickener powder may consist up to 60% of the dispersion by weight thus it is highly concentrated. Said liquefied thickener includes following theoretical basis:

First, the thickener power is a synthetic water-soluble polymer, which is one of polymer-based fracturing fluid thickeners. The thickener powder is introduced with side groups which may form multi-level structures. After prepared into a fracturing fluid, its diluted solution contains a strong physical structure and may replace guar gum-based fracturing fluids. Because polymer structures of said thickener powder contain a large quantity of hydrophilic groups, which lead to excellent solubility and no insoluble objects remaining once dissolved, there is no residue produced during processes of preparation, crosslinking, gel breaking and flowing back. The multi-level structures of the side groups and the hydrophilic groups work together to produce the fracturing fluid with superior suspending capacity, reduced friction, and excellent thermo and salt resistances; all of which are especially suited for in situ operations, particularly, fracturing operations in large scales.

Second, a dissolution process of the thickener powder may be divided into five steps:
1. hydrating;
2. swelling;
3. dispersing;
4. dissolving; and,
5. curing.

The first three steps, hydrating, swelling and dispersing are of most time-consuming and require sufficient stirring. The liquefied thickener of the present invention contains a plurality of water-soluble organic solvents; it is highly hydrophilic thus it may carry fine powders of the thickener powder and instantly disperse into water without introducing “fish eyes”, resulting in reduced time requests for the first hydrating and the third dispersing steps. The thickener power has been homogeneously dispersed among the water-soluble organic solvents, thus leads to an increased specific surface area with the large quantity of the hydrophilic groups. It may instantly integrate with water thus result in a quick swelling, and reduced time request for the second swelling step.

In summary, the liquefied thickener of the present invention may preliminarily eliminate three most time consuming steps during the dissolution process for the thickener powder, wherein said liquefied thickener may be able to substantially form a solution within few seconds after mixed with the water, instantly tackify said solution, which then could be mixed with sand, crosslinked, and pumped, leading to a continuous process for preparing and applying of the fracturing fluid.

In one embodiment, the present invention is a method of preparing the liquefied thickener comprises following steps:

The first step: preparing the water-soluble organic solvent:
a) maintaining a temperature in a stirring reactor at 10-30° C.,
b) adding by total weight: sulfoxide based organic solvents 50-60%;
c) adding by total weight: amide based organic solvents 20-25%, stirring for 10-30 min;
d) adding by total weight: organic alcohols 10-28%, stirring for 10-30 min;
e) adding by total weight: formate 2-5%; and,
f) stirring for 10-30 min till a transparent and homogeneous liquid of the water-soluble organic solvent is formed.

According to the present invention, the sulfoxide based organic solvents may include but not limited to at least one of the following: dimethylsulfoxide, sulfoxide, and n-butyl sulfone. The amide based organic solvents may include but not limited to at least one of the following: dimethyl formamide, dimethyl acetamide, and diethyl formamide. The organic alcohols consist of mono-hydroxy alcohol organic solvents and/or polyhydroxy alcohol organic solvents. The mono-hydroxy alcohol organic solvents may include but not limited to at least one of the following: ethanol, n-propanol, iso-butanol and the like. The polyhydroxy alcohol organic solvents may include but not limited to at least one of the following: ethylene glycol, propylene glycol, glycerin and the like. The formate based solvents may include but not limited to sodium formate, and potassium formate.

Compounds introduced into the water-soluble organic solvent have their functions described as: the sulfoxide based organic solvents are a key organic solvent; the amide based organic solvents are a secondary organic solvent; the organic alcohols are solubility modifiers; the formate salt based solvents are performance moderators.

Step two: add the thickener powder of 200-600 mesh:
1. keeping stirring the water-soluble organic solvent;
2. adding the thickener powder of 200-600 mesh;
3. stirring for 10-30 min until a milky dispersion is formed.

Accordingly, giving the total weight of the water-soluble organic solvent and the thickener powder in the Step two as 100%, the water-soluble organic solvent is 40-55%, and the thickener powder is 45-60% by weight.

The liquefied thickener of the present invention has a certain viscosity, it may be stratified after left standing for a while but may regain its homogeousness with a quick stirring. Said liquefied thickener has its evaluating indexes as: density of 1.0-1.3 g/cm³; gelling time less than or equal to 15 s; and the viscosity of its 1.0% solution greater than or equal to 30 mPa·s.

The viscosity of the liquefied thickener described hereabove is obtained by measuring its viscosity at 170 s⁻¹ using a rheometer (such as Haake Rheometer or equivalent instrument) or a six-speed rotational viscometer.

### Embodiments

Embodiment 1, preparing and testing Liquefied thickener 1:
1. adding 78 g of dimethyl sulfoxide into a reactor while keeping stirring;
2. adding dimethylacetamide 34.6 g, stirred for 20 min;
3. adding n-propanol 15 g and isopropanol 18 g, stirring for 30 min;
4. adding sodium 4.5 g, stirring for 10 min; and,
5. adding the fracturing powder 127.8 g while keeping stirring, stirring for 20 min.

The Liquid Thickener 1 prepared from the Embodiment 1 is a milky dispersion having a density of 1.13 g/cm³; gelling time 15 s; and the viscosity of its 1.0% solution 42 mPa·s.

Embodiment 2, preparing and testing Liquefied thickener 2:
1. adding 116 g dibutyle sulfoxide in the reactor while keeping stirring;
2. adding dimethylformamide 24 g and diethyl formamide 26 g, stirring for 15 min;
3. adding ethanol 24 g, stirring for 15 min;
4. added potassium 10 g, stirring for 15 min; and,
5. adding the thickener powder 244.4 g while keeping stirring, stirring for 25 min.

The Liquid Thickner 2 prepared from the Embodiment 2 is a milky dispersion having a density of 1.24 g/cm³; gelling time 15 s; and the viscosity of its 1.0% solution 56 mPa·s.

Embodiment 3, preparing and testing Liquefied thickener 3:
1. adding 99 g n-butyl sulfoxide in the reactor while keeping stirring;
2. adding dimethylformamide 37.8 g, stirring for 30 min;
3. adding n-propanol 36 g, stirring for 30 min;
4. adding sodium 3.6 g and potassium 3.6 g, stirred for 30 min; and
5. adding the thickener powder 180 g while keeping stirring, stirring 30 min.

The Liquid Thickner 3 prepared from the Embodiment 3 is a milky dispersion having a density of 1.18 g/cm³; gelling time 15 s; and the viscosity of its 1.0% solution 48 mPa·s.

It is to be understood that the use of “including”, “comprising” or “consisting of” and variations thereof herein is meant to encompass the items listed thereafter and equivalents thereof as well as additional items; the terms “a” and “an” herein do not denote a limitation of quantity, but rather denote the presence of at least one of the referenced item; and, the use of terms “first”, “second”, and the like, herein do not denote any order, quantity, or importance, but rather are used to distinguish one element from another.

It is to be understood that the above embodiments and examples are provided as illustrations only, and do not in any way restrict or define the scope of the present invention. Various other embodiments may also be within the scope of the claims.

1. A liquefied polymer fracturing fluid thickener, which has evaluation indexes of a density of 1.0-1.3 g/cm³, a gelling time less than or equal to 15 s, and a viscosity of its 1.0% solution greater than or equal to 30 mPa·s; said thickener is prepared by a process comprises:
a) preparing an organic solvent solution by adding following organic solvents by sequence while stirring: sulfoxide based organic solvents, amide based organic solvents, mono-hydroxy alcohol organic solvents and/or polyhydroxy alcohol organic solvents, and formate based solvents; wherein giving the total weight of said organic solvents as 100%, the sulfoxide based organic solvents consists 50-60%, the amide based organic solvents consists 20-25%, the mono-hydroxy alcohol organic solvents and/or the polyhydroxy alcohol organic solvents consist 10-28%, and the formate based solvents consists 2-5%; and,
b) introducing a thickener powder into the organic solvent solution while keeping stirring, wherein giving the total weight of the organic solvent solution and the thickener powder as 100%, the organic solvent solution consists of 40-55%, and the thickener powder consists of 45-60%.

2. The process of claiml, wherein the thickener powder has a formula as:

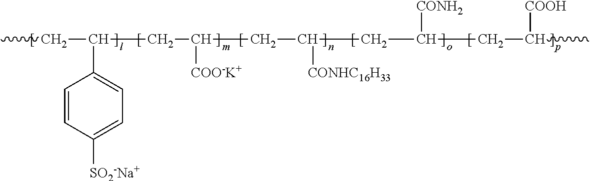

3. The process of claim 2, wherein the thickener powder is between 200-600 mesh.

4. The process of claim 1, wherein the sulfoxide based organic solvents are selected from at least one of following: dimethylsulfoxide, sulfoxide, n-butyl sulfone; the amide based organic solvents are selected from at least one of following: dimethyl formamide, dimethyl acetamide, and diethyl formamide; the mono-hydroxy alcohol organic solvents are selected from at least one of following: ethanol, n-propanol, and iso-butanol; the polyhydroxy alcohol organic solvents are selected from at least one of following: ethylene glycol, propylene glycol, and glycerin; the formate based solvents are selected from at least one of following: sodium formate, and potassium formate.

5. A method of preparing to a liquefied polymer fracturing fluid thickener, said thickener has evaluation indexes of a density of 1.0-1.3 g/cm³, a gelling time less than or equal to 15 s, and a viscosity of its 1.0% solution greater than or equal to 30 mPa·s; which comprises:
a) preparing an organic solvent solution by adding following organic solvents by sequence while stirring: sulfoxide based organic solvents, amide based organic solvents, mono-hydroxy alcohol organic solvents and/or polyhydroxy alcohol organic solvents, and formate based solvents; wherein giving the total weight of said organic solvents as 100%, the sulfoxide based organic solvents consists 50-60%, the amide based organic solvents consists 20-25%, the mono-hydroxy alcohol organic solvents and/or the polyhydroxy alcohol organic solvents consist 10-28%, and the formate based solvents consists 2-5%; and,
b) introducing a thickener powder into the organic solvent solution while keeping stirring, wherein giving the total weight of the organic solvent solution and the thickener powder as 100%. the organic solvent solution consists of 40-55%, and the thickener powder consists of 45-60%.

6. The method of claim 5, wherein the thickener powder has a formula as:

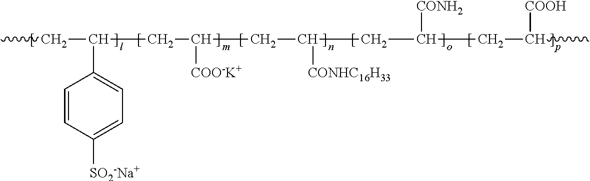

7. The thickener powder of claim 6, which is between 200-600 mesh.

8. The method of claim 5, wherein the sulfoxide based organic solvents are selected from at least one of following: dimethylsulfoxide, sulfoxide, n-butyl sulfone; the amide based organic solvents are selected from at least one of following: dimethyl formamide, dimethyl acetamide, and diethyl formamide; the mono-hydroxy alcohol organic solvents are selected from at least one of following: ethanol, n-propanol, and iso-butanol; the polyhydroxy alcohol organic solvents are selected from at least one of following: ethylene glycol, propylene glycol, and glycerin; the formate based solvents are selected from at least one of following: sodium formate, and potassium formate.
